(19) United States
(12) Patent Application Publication
(10) Pub. No.: US 2013/0328341 A1
(43) Pub. Date: Dec. 12, 2013

(54) CARGO MANAGEMENT SYSTEM

(71) Applicants: Karin Lovett, Novi, MI (US); Patrick Maguire, Ann Arbor, MI (US)

(72) Inventors: Patrick Daniel Maguire, Ann Arbor, MI (US); Karin Lovett, Novi, MI (US)

(73) Assignee: FORD GLOBAL TECHNOLOGIES LLC, Dearborn, MI (US)

(21) Appl. No.: 13/966,225

(22) Filed: Aug. 13, 2013

Related U.S. Application Data
(62) Division of application No. 12/604,746, filed on Oct. 23, 2009.

(51) Int. Cl. B60N 2/06; B60N 2/36

(52) U.S. Cl. CPC B60N 2/065; B60N 2/36; B60N 2002/363
USPC 296/65.13

(57) ABSTRACT

A cargo management system includes a vehicle floor pan, a passenger seat having a seat back and a seat cushion, and an adjustable load floor. The passenger seat is disposed on the vehicle floor pan. The passenger seat has a seatback that is pivotally mounted to the seat cushion. The adjustable load floor is disposed above the vehicle floor pan. The adjustable load floor has a rear end and a front end wherein the front end is operatively configured to engage with the base of the seatback. The adjustable load floor being is operatively configured to move between a first position and a second position as the seat back moves between the upright position and the collapsed position.

### CROSS REFERENCES TO RELATED APPLICATION

The present disclosure is a divisional of and claims benefit of priority under 35 U.S.C. 120 from U.S. Ser. No. 12/604746, filed on Oct. 23, 2009, the entire contents of which is incorporated herein by reference.

### BACKGROUND

The present disclosure relates generally to cargo load floors in automotive vehicles, including such devices having multiple positions.

Sport utility vehicles (SUVs), multi-activity vehicles (MAVs), crossovers, and even sedans generally have cargo regions behind one or more rows of passenger seats. Often these rows of passenger seats are collapsed or folded to enhance the size of the cargo region. To achieve a flat load floor in the cargo region when the row of seats is collapsed, some automotive vehicle designs include a panel which connects the seat back to the pre-existing load floor. Typically, the added connecting panel is positioned at an angle which is different from both the pre-existing load floor and the seat back. Such traditional designs compromise overall cargo volume. Components beneath the seat cushions, such as a battery system for hybrid vehicles, might further reduce the size of the cargo region.

Other cargo assemblies provide flat load floors in cargo regions by designing the row of passenger seats to fold completely flat. The problem with these assemblies is that, especially recently, vehicles are under tighter packaging constraints, and rows of collapsible seats in these vehicles are not able to fold completely flat. More current cargo assemblies attempt to address this situation by providing large, removable accessories that serve as cargo load floors. Despite their ability to align with a surface on a collapsed seatback, to achieve this state of alignment these large accessories must be manually flipped 180 degrees depending on the posture of the seatback.

### SUMMARY

A cargo management system for a vehicle is provided according to the embodiments disclosed herein. The cargo management system includes a vehicle floor pan, a passenger seat having a seat back and a seat cushion, and an adjustable load floor. The passenger seat is disposed on the vehicle floor pan or other component such as a HEV battery. The passenger seat has a seatback that is pivotally mounted to a base member. The adjustable load floor is disposed above the vehicle floor pan. The adjustable load floor has a rear end and a front end wherein the front end is operatively configured to engage with a lower portion of the seatback. The adjustable load floor may be operatively configured to move between a first position and a second position as the seat back moves between the upright position and the collapsed position.

### BRIEF DESCRIPTION OF THE DRAWINGS

Features and advantages of embodiments of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 shows a side view of an embodiment of the cargo management system where the seat back is in the collapsed position.

FIG. 2A shows a side view of an embodiment of the cargo management system where the seat back is in the upright position.

FIG. 2B shows a side view of an embodiment of the cargo management system where the seat back is in the upright position and the load floor is pivoted up.

FIG. 3 shows a side view of an embodiment of the cargo management system where the seat back is shown in both the upright position (in solid) and in the collapsed position (in phantom).

FIG. 4 shows a side view of an embodiment of the cargo management system where the seat is adjusted to move toward the front position (shown in phantom).

FIG. 5A shows an enlarged, partial side view of an embodiment of the cargo management system where the adjustable load floor is connected to the seat using a hinge-type connection, and the seat is in the upright position.

FIG. 5B shows an enlarged, partial side view of an embodiment of the cargo management system where the adjustable load floor is connected to the seat using a hinge-type connection, and the seat is in the collapsed position.

FIG. 6A shows an enlarged, partial side view of an embodiment of the cargo management system where the adjustable load floor is connected to or engages with the seat using a hook-type connection, and the seat is in the upright position.

FIG. 6B shows an enlarged, partial side view of an embodiment of the cargo management system where the adjustable load floor is connected to or may be engaged with the seat using a hook-type connection, and the seat is in the collapsed position.

FIG. 7A shows an enlarged, partial side view of an embodiment of the cargo management system where the adjustable load floor is connected to the seat using a linkage connection, and the seat is in the upright position.

FIG. 7B shows an enlarged, partial side view of an embodiment of the cargo management system where the adjustable load floor is connected to the seat using a linkage connection, and the seat is in the collapsed position.

FIG. 7C shows an enlarged, partial side view of another embodiment of the cargo management system where the linkage connection may be detached from the seat.

FIG. 8 shows a side view of yet another embodiment of the cargo management system where a second linkage connection is disposed at the rear end of the adjustable load floor.

### DETAILED DESCRIPTION

The present disclosure provides a cargo management system 10 which increases cargo volume in the spare tire berth 12 below the adjustable load floor 14 when a passenger seat 16 is collapsed by automatically aligning the adjustable load floor 14 with the rear surface 22 of the seatback 18 when the row of passenger seats 16 is collapsed. The adjustable load floor 14 is also capable of automatically lowering when the passenger seat 16 is in the upright position.

A cargo management system for a vehicle includes a vehicle floor pan 20, a passenger seat 16, and an adjustable load floor 14. The passenger seat 16 is coupled to the vehicle floor pan 20. The passenger seat 16 includes a seatback 18 that is pivotally mounted to a base member 24 such as a seat cushion, vehicle floor pan 20, C-Pillar (not shown), HEV battery (not shown) or other energy storage device. The seatback 18 includes a front surface, a back surface 22, and a base 26. The seatback 18 is generally vertical in an upright position and substantially horizontal in a collapsed position.

The adjustable load floor 14 is disposed above the vehicle floor pan 20. It is to be understood that the vehicle floor pan 20 may be uneven due to the formation of wheel wells and/or cavities created to accommodate other vehicle components. It is also to be understood that the adjustable load floor 14 may not be immediately adjacent to the vehicle load floor depending on the vehicle configuration and/or storage constraints. The adjustable load floor 14 includes a rear end 60 and a front end 52. The front end 52 is operatively configured to engage with the base 26 of the seatback 18.

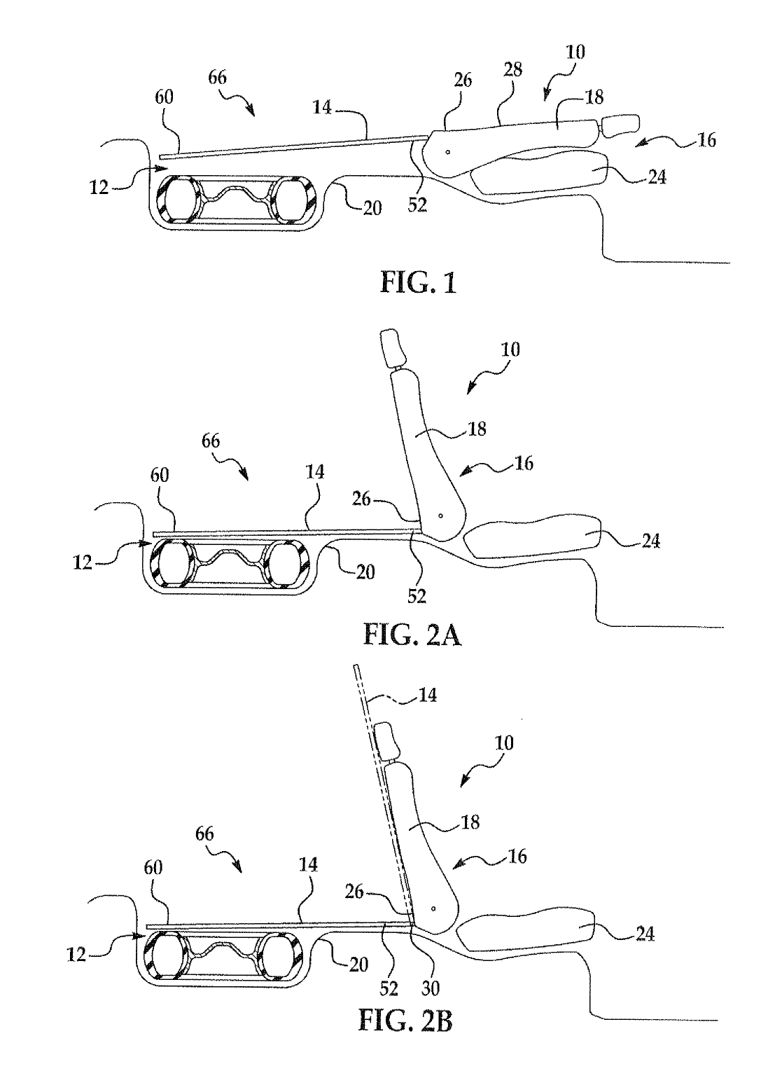

Accordingly, the adjustable load floor 14 may be in a first position when the seatback 18 is in the upright position and the adjustable load floor 14 may be in an inclined position (or second position) when the seatback 18 is in the collapsed position as shown in FIGS. 1 and 2A. The adjustable load floor 14 may be substantially flush with the back surface of the seatback 18 when the seatback 18 is collapsed in the second position.

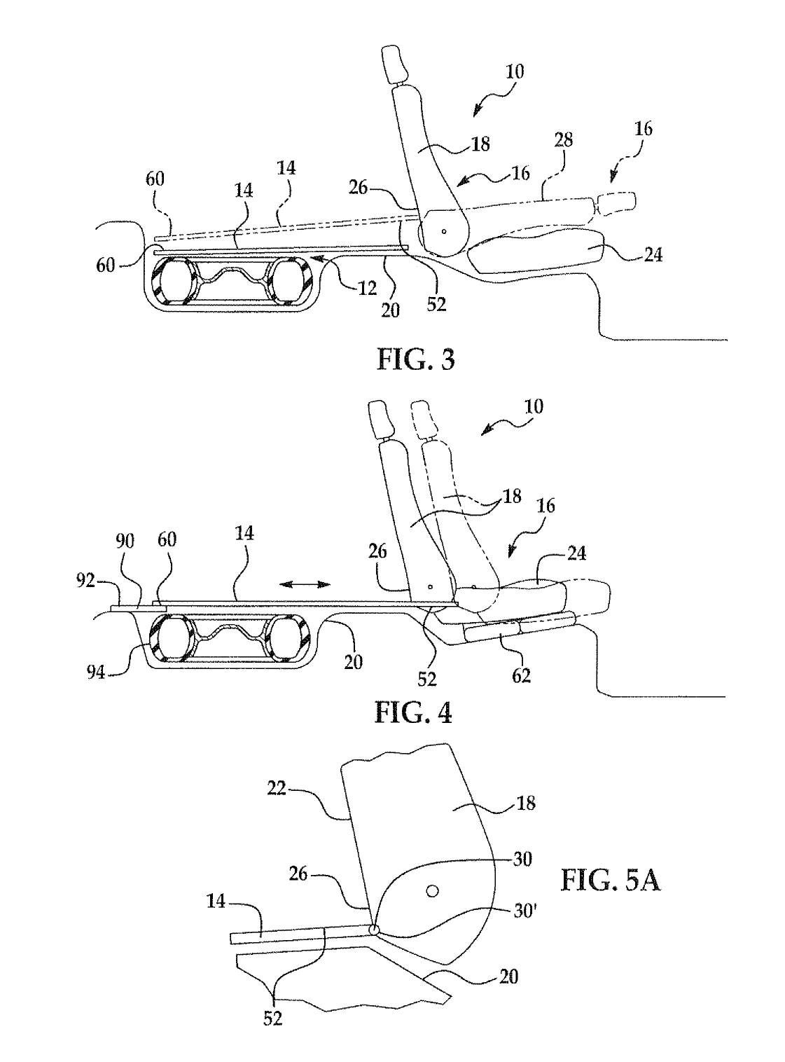

The adjustable load floor 14 therefore moves between a first position and a second position as the seat back 18 moves between the upright position and the collapsed position. As shown in FIG. 3, the cargo area below the adjustable load floor 14 increases in volume as the passenger seat 16 is collapsed from the upright position or (first position) to the collapsed position (second position). Accordingly, a user is provided with more storage capability below the load floor 14 when the seat back 18 is in the collapsed position.

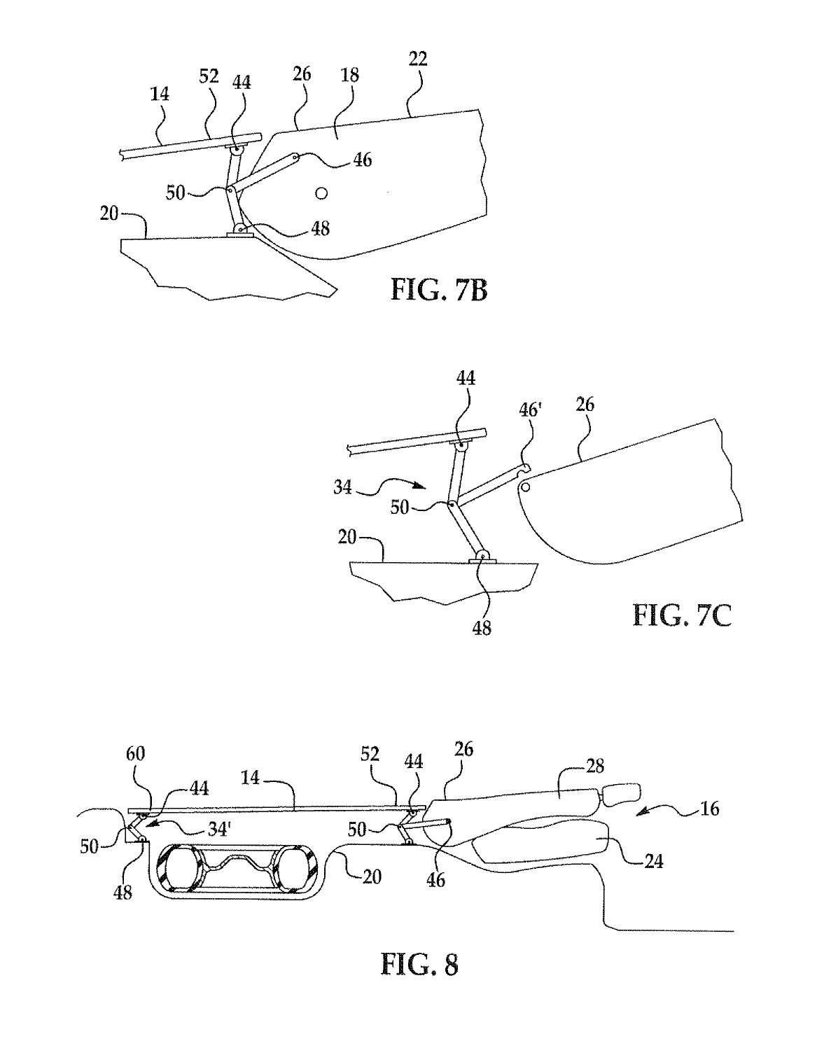

Referring to the embodiment in FIG. 3, the slope of the adjustable load floor 14 may adjust to match that of the seatback 18. This provides a user with a flat surface 28 (the load floor and the seat back) as the cargo area is increased within the vehicle. If the seatback 18 folds or collapses to a substantially horizontal position, the adjustable load floor 18 may rise at a rear end 60 via a second linkage mechanism (not shown). The second linkage mechanism may be constructed in a similar fashion to the at least two linkages 34 (shown in FIG. 7A and 7B) that are disposed at the front end 52 of the adjustable load floor 14.

Referring now to the embodiment in FIG. 4, the cargo management system 10 of the present disclosure may further include a sliding track assembly 62 disposed between the passenger seat 16 and the vehicle floor pan 20. The passenger seat 16 is slidably affixed to the sliding track assembly 62 so that the passenger seat 16 is slidably movable in a range of fore-aft positions. The adjustable load floor 14 is engaged to the base 26 of the seatback 18 moves fore-aft with the seatback 18 and moves from front to back as the passenger seat 16 moves from front to back. As the passenger seat 16 moves to the front of the vehicle, the adjustable load floor 14 moves forward (along with seatback 18) relative to rear base 90 at the rear end of the adjustable load floor 14. In contrast, when the passenger seat 16 moves to the back of the vehicle, the adjustable load floor 14 again moves relative to rear base 90 by sliding over rear base 90 at the rear end of the adjustable load floor 14. It is to be understood that where rear base 90 overhangs any portion of the tire 94 (as shown in FIG. 4) the rear base 90 may be pivotable about its rear portion 92 so as to allow the flap to move out of the way when a user seeks to gain access to the tire 94. Otherwise, rear base 90 may be affixed or coupled to the vehicle floor pan 20 or vehicle body structure (not shown).

It is to be understood that a cargo region 66 may also be provided where the cargo region 66 is defined by the vehicle (not shown) (such as, but not limited to a liftgate or tailgate and vehicle roof), the adjustable load floor 14 and seatback 18. The flat surface 28 of the cargo region 66 can change depending on the seat configuration. When the passenger seat 16 is in the upright position, the flat surface 28 of the cargo region 66 is the adjustable load floor 14. However when the seatback 18 is in the collapsed position, the flat surface 28 of the cargo region 66 is made up of the adjustable load floor 14 and the seat back. Again, the slope of the adjustable load floor 14 and the seatback 18 are substantially the same.

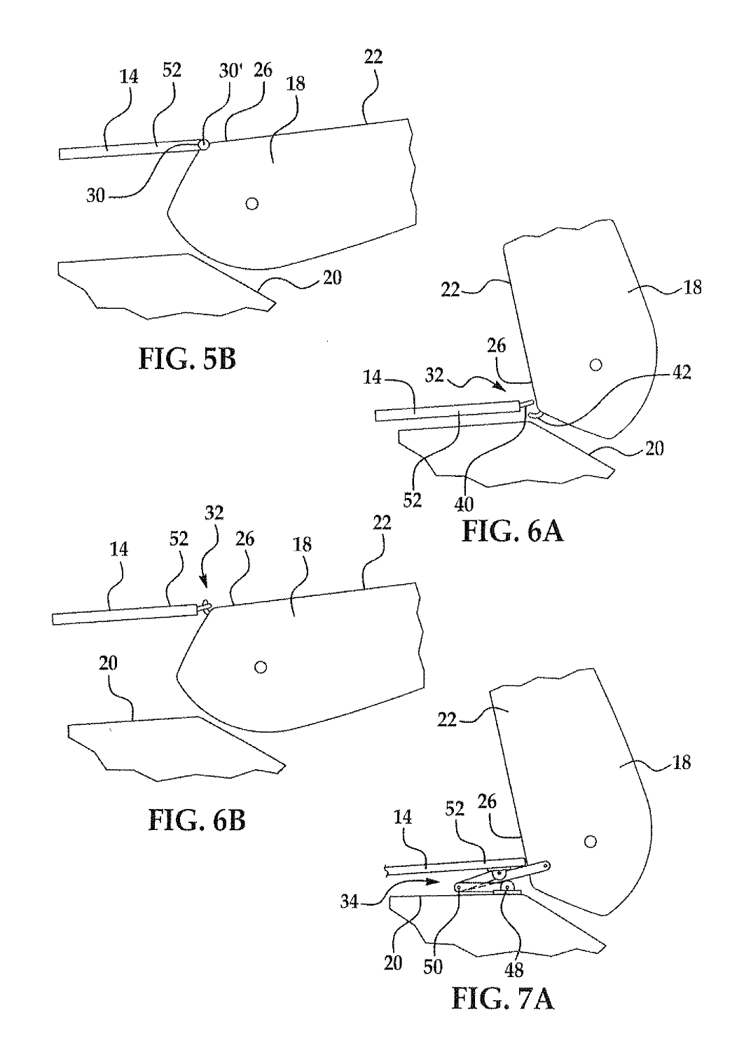

The adjustable load floor 14 may be engaged to the base 26 of the seatback 18 through a variety of arrangements, such as, but not limited to a hinge 30 design or a hook and loop 32 configuration. A non-limiting example of a hinge 30 design that may be implemented is a piano hinge 30′ such as that shown in FIGS. 5A and 5B. It is also to be understood that the adjustable load floor may pivot upward at the piano hinge 30′ as shown in FIG. 2B so that a user may access the storage area under the adjustable load floor.

With reference to FIG. 5A, the seatback 18 is shown in the upright position such that the seatback 18 is substantially perpendicular to the adjustable load floor 14. The change in the load floor 14 is illustrated in FIG. 5B when the seatback 18 is in the collapsed position. The piano hinge 30′ and the front end 52 of the load floor 14 moves upwards as the seatback 18 moves to the collapsed position. As shown in FIG. 5B, the slope of the load floor 14 and the seatback 18 are substantially the same resulting in a flat surface 28 (consisting of the load floor 14 and the seatback 18). Furthermore, there is increased cargo volume below the load floor 14 proximate to the hinge 30 as a result of the adjustment in the load floor 14. As shown in FIG. 8, it is also to be understood that the height of the load floor at the rear end 60 of the load floor 14 may be adjusted via a corresponding linkage to match height of the front end 52 of the load floor 14.

Referring now to the embodiment in FIGS. 6A and 6B, a hook and loop 32 configuration is shown. The hook and loop 32 configuration may be a manual design where the front end 52 of the rigid adjustable load floor 14 is removably affixed to the base 26 of the seatback 18. As shown in the non-limiting example of FIGS. 6A and 6B, the hook 40 may be affixed to the front end 52 of the adjustable load floor 14 and the loop 42 may be affixed to the base 26 of the seatback 18. In order to affix or engage the two components together, a user may need to manually insert the hook 40 of the adjustable load floor 14 into the loop 42 of the passenger seat 16.

Referring now to the embodiments shown in FIGS. 7A and 7B, another embodiment of the cargo management system 10 may include at least two linkages 34 which are implemented to engage the adjustable load floor 14 to the base 26 of the seat back. As shown, a first end 44 of the at least two linkages 34 is affixed to the adjustable load floor 14 and a second end 46 of the at least two linkages 34 is affixed to the base 26 of the seatback 18, and a third end 48 of the at least two linkages 34 may be affixed to the vehicle floor pan 20. As shown in FIG. 7B, as the seatback 18 collapses the second end 46 of the at least two linkages 34 is pulled toward the front of the vehicle thereby expanding the linkage 34 by pulling the middle joint 50 forward. Accordingly, the first end 44 moves the front end 52 of the adjustable load floor 14 upward so that the slope of the adjustable load floor 14 substantially matches the slope of the collapsed seatback 18. Accordingly, at least two linkages 34 raise and lower the rear end of the adjustable load floor 14 as the seatback 18 moves between an upright position and a collapsed position. Referring now to FIG. 7C, another embodiment is shown where the second end 46′ of the linkage 34 may be configured as a hook such that the load floor 14 having a linkage system may be decoupled from the seat.

With reference to FIG. 8, a second linkage 34′ may be disposed at the rear end 60 of the adjustable load floor 14 so that as the seatback 18 collapses the second end 46 of the at least two linkages 34 is pulled toward the front of the vehicle thereby expanding the linkage 34 by pulling the middle joint 50 forward. Accordingly, the first end 44 moves the front end 52 of the adjustable load floor 14 upward so that the slope of the adjustable load floor 14 substantially matches the slope of the collapsed seatback 18. Accordingly, as the adjustable load floor 14 moves up upward, the second linkage at 34′ also expands to raise the height of the adjustable load floor 14 at the rear end 60.

Referring back to FIGS. 1 and 2, the cargo management system 10 of the present disclosure may further include a spare tire berth 12 in the vehicle floor pan 20 wherein the spare tire berth 12 is disposed below the adjustable load floor 14. The adjustable load floor 14 conceals the spare tire berth 12 from the cargo region. As shown in FIG. 1, the area below the adjustable load floor 14 may have increased cargo volume when the seat back is in the collapsed position.

While multiple embodiments have been described in detail, it will be apparent to those skilled in the art that the disclosed embodiments may be modified. Therefore, the foregoing description is to be considered exemplary rather than limiting.

What is claimed is:

1. A cargo management system for a vehicle comprising:
a vehicle floor pan;
a passenger seat disposed on the vehicle floor pan, the passenger seat having a seatback pivotally mounted to a base member, wherein the seatback has at least a front surface, a back surface, and a base, the seatback being generally vertical in an upright position and substantially horizontal in a collapsed position;
an adjustable load floor disposed above the vehicle floor pan, the adjustable load floor having a rear end and a front end operatively configured to engage with the base of the seatback, the adjustable load floor being operatively configured to move between a first position and a second position as the seat back moves between the upright position and the collapsed position; and
a sliding track assembly disposed between the passenger seat and the vehicle floor pan, the passenger seat slidably affixed to the sliding track assembly so that the passenger seat is slidably movable in a range of fore-aft positions, and the adjustable load floor being engaged to the base of the seatback moves fore-aft with the seatback.

2. The cargo management system of claim 1 wherein the adjustable load floor is engaged to the base of the seatback via a mechanical interlock.

3. The cargo management system of claim 2 wherein the mechanical interlock is a hook and loop configuration.
